(19) United States
(12) Patent Application Publication
(10) Pub. No.: US 2026/0150051 A1
(43) Pub. Date: May 28, 2026

(54) METHOD AND APPARATUS FOR RECEIVING WAKE-UP SIGNAL, METHOD AND APPARATUS FOR SENDING WAKE-UP SIGNAL, AND READABLE STORAGE MEDIUM

(71) Applicant: Beijing Xiaomi Mobile Software Co., Ltd., Beijing (CN)

(72) Inventor: Ziquan HU, Beijing (CN)

(21) Appl. No.: 19/123,187

(22) PCT Filed: Oct. 26, 2022
(86) PCT No.: PCT/CN2022/127771

§ 371 Date: Apr. 22, 2025

(51) Int. Cl. H04W 52/02; H04W 52/34

(52) U.S. Cl. CPC H04W 52/0235; H04W 52/34

(57) ABSTRACT

A method for receiving a wake-up signal is performed by a user equipment, and includes: receiving a wake-up signal (WUS) sent by a network device; and performing a measurement through a low-power transceiver or a main receiver.

### CROSS-REFERENCE TO RELATED APPLICATION

The application is a U.S. National Stage of International Application No. PCT/CN2022/127771 filed on Oct. 26, 2022, the entire content of which is incorporated herein by reference.

### TECHNICAL FIELD

The present disclosure relates to the technical field of wireless communication, and in particular, to a method and apparatus for receiving and sending a wake-up signal, and a readable storage medium.

### BACKGROUND

In release 16 (R16) of the 3rd generation partnership project (3GPP), a power saving signal in the connected state is introduced, such as the wake up signal (WUS) or the downlink control information for power saving (DCP). The user equipment (UE) will only monitor the physical downlink control channel (PDCCH) when it detects the WUS signal: otherwise, the UE will skip the monitoring of the PDCCH.

In R17, for the discontinuous reception (DRX) scenario in idle state, a power saving signal such as the paging early indication (PEI) is typically configured prior to the paging occasion (PO). The UE will only monitor the paging DCI when it detects the PEI, otherwise it will skip the paging DCI. At the same time, the mechanism of skipping the monitoring of the PDCCH is also introduced in R17, where the network indicates to the UE via DCI to skip PDCCH monitoring for a period of time or switch the search space sets.

### SUMMARY

The present disclosure provides a method and an apparatus for receiving and sending a wake-up signal, and a readable storage medium.

In a first aspect, the present disclosure provides a method for receiving a wake-up signal, which is performed by a user equipment, and the method includes:
receiving a wake-up signal (WUS) sent by a network device; and
performing a measurement through a low-power transceiver or a main receiver.

In a second aspect, the present disclosure provides a method for sending a wake-up signal, which is performed by a network device, and the method includes:
sending a wake-up signal (WUS) to a user equipment.

In a third aspect, the present disclosure provides an apparatus for receiving a wake-up signal, where the apparatus may be configured to execute the steps performed by a user equipment in the first aspect. The user equipment may implement various functions of the above methods in the form of hardware structures, software modules, or a combination of the hardware structures and the software modules.

When the apparatus illustrated in the third aspect is implemented by software modules, the apparatus may include a transceiver module and a processing module coupled to each other, where the transceiver module may be configured to support the communication apparatus to perform communication, and the processing module may be configured for the communication apparatus to perform processing operations, such as generating information/messages to be sent, or processing received signals to obtain information/messages.

When executing the steps described in the first aspect above, the transceiver module is configured to receive a wake-up signal (WUS) sent by a network device; and the processing module is configured to perform a measurement through a low-power transceiver or a main receiver.

In a fourth aspect, the present disclosure provides an apparatus for sending a wake-up signal, where the apparatus may be configured to execute the steps performed by a network device in the second aspect. The network device may implement various functions of the above methods in the form of hardware structures, software modules, or a combination of the hardware structures and the software modules.

When the apparatus illustrated in the fourth aspect is implemented by a software module, the apparatus may include a transceiver module, where the transceiver module may be configured to support the communication apparatus to perform communication.

When executing the steps described in the second aspect above, the transceiver module is configured to send a wake-up signal (WUS) to a user equipment.

In a fifth aspect, the present disclosure provides a communication apparatus, including a processor and a memory: the memory is configured to store a computer program; and the processor is configured to execute the computer program to implement the first aspect.

In a sixth aspect, the present disclosure provides a communication apparatus, including a processor and a memory: the memory is configured to store a computer program; and the processor is configured to execute the computer program to implement the second aspect.

In the seventh aspect, the present disclosure provides a computer-readable storage medium, where the computer-readable storage medium stores instructions (or referred to as computer programs, programs), which, when called and executed on a computer, enable the computer to execute the above-mentioned first aspect.

In an eighth aspect, the present disclosure provides a computer-readable storage medium, where the computer-readable storage medium stores instructions (or referred to as computer programs, programs), which, when called and executed on a computer, enable the computer to execute the above-mentioned second aspect.

It should be understood that the above general description and the following detailed description are merely exemplary and explanatory, and do not limit the present disclosure.

### BRIEF DESCRIPTION OF THE DRAWINGS

The accompanying drawings herein, which are incorporated into and constitute a part of the specification, illustrate example embodiments of the present disclosure and, together with the specification, serve to explain the principles of the embodiments of the present disclosure.

FIG. 1 is a schematic diagram of a wireless communication system architecture provided by an embodiment of the present disclosure.

FIG. 2 is a flowchart of a method for receiving and sending a wake-up signal shown according to an exemplary embodiment.

FIG. 3 is a flowchart of a method for receiving a wake-up signal shown according to an exemplary embodiment.

FIG. 4 is a flowchart of another method for receiving a wake-up signal shown according to an exemplary embodiment.

FIG. 5 is a flowchart of another method for receiving a wake-up signal shown according to an exemplary embodiment.

FIG. 6 is a flowchart of another method for receiving a wake-up signal shown according to an exemplary embodiment.

FIG. 7 is a flowchart of a method for sending a wake-up signal shown according to an exemplary embodiment.

FIG. 8 is a flowchart of another method for sending a wake-up signal shown according to an exemplary embodiment.

FIG. 9 is a block diagram of an apparatus for receiving a wake-up signal shown according to an exemplary embodiment.

FIG. 10 is a block diagram of a user equipment shown according to an exemplary embodiment.

FIG. 11 is a block diagram of an apparatus for sending a wake-up signal shown according to an exemplary embodiment.

FIG. 12 is a block diagram of a communication apparatus shown according to an exemplary embodiment.

### DETAILED DESCRIPTION

Exemplary embodiments will be described in detail herein, examples of which are represented in the accompanying drawings. When the following description relates to the drawings, the same numerals in different accompanying drawings represent the same or similar elements unless otherwise indicated. The implementations described in the following exemplary embodiments do not represent all implementations consistent with the present disclosure. To the contrary, they are merely examples of apparatuses and methods that are consistent with some aspects of the present disclosure, as detailed in the appended claims.

Terms used in the present disclosure are used solely for the purpose of describing certain embodiments and are not intended to limit the present disclosure. The singular forms of “a/an”, “said” and “the” used in the embodiments of the present disclosure and the appended claims are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various information in the present disclosure. Such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “when . . . ” or “in the case . . . ” or “in response to determination”.

In R18, a low power wake up signal (LP WUS) is introduced, where the UE may use a separate low power transceiver (low power wake up receiver, LP WUR) to monitor and receive the LP WUS, while the main receiver (modem or main radio) is in sleep mode. The main receiver is woken up to send and receive data after the low power receiver receives the LP WUS, thereby achieving energy saving for the UE. The measurement method for this wake-up scenario needs to be provided.

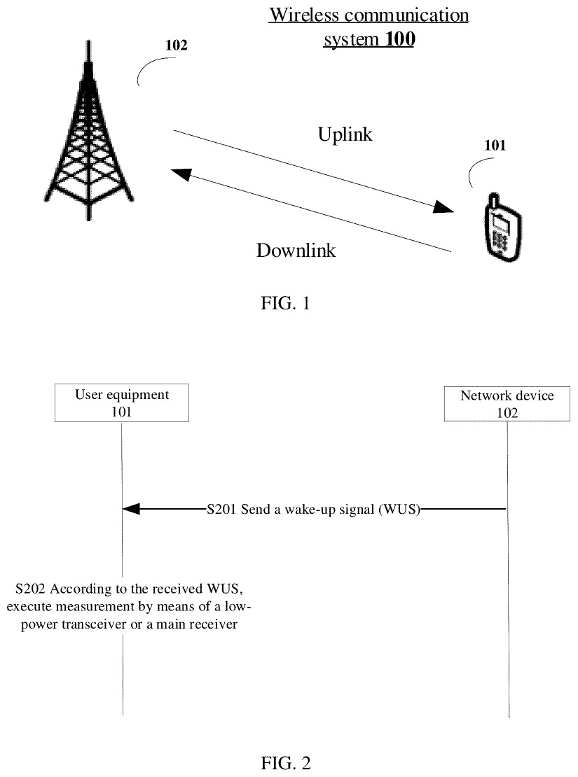

As shown in FIG. 1, a method for receiving and sending a wake-up signal provided by an embodiment of the present disclosure may be applied to a wireless communication system 100, and the wireless communication system may include a user equipment 101 and a network device 102. Herein, the user equipment 101 is configured to support carrier aggregation and may be connected to a plurality of carrier units of the network device 102, which include one primary carrier unit and one or more secondary carrier units.

It should be understood that the above wireless communication system 100 may be adapted to both low frequency scenarios and high frequency scenarios. The application scenario of the wireless communication system 100 includes, but is not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-Generation (5G) system, a new radio (NR) communication system, or a future evolved public land mobile network (PLMN) system, etc.

The user equipment 101 shown above may be a terminal, an access terminal, a terminal unit, a terminal station, a mobile station (MS), a remote station, a remote terminal, a mobile terminal, a wireless communication device, a terminal agent, a terminal device, or the like. The user equipment 101 may have a wireless transceiver function, which is capable of communicating (for example, wireless communication) with one or more network devices of one or more communication systems, and receiving network services provided by the network devices, where the network device herein includes, but is not limited to, the illustrated network device 102.

The user equipment 101 may be a cellular telephone, a cordless telephone, a session initiation protocol (SIP) telephone, a wireless local loop (WLL) station, a personal digital assistant (PDA) device, a handheld device with a wireless communication function, a computing device or other processing device connected to a wireless modem, a vehicle-mounted device, a wearable device, a terminal device in a future 5G network or a future evolved PLMN network, or the like.

The network device 102 may be an access network device (or access network station). The access network device refers to a device that provides network access functions, such as a radio access network (RAN) base station, etc. The network device 103 may specifically include a base station (BS), or include a base station and a radio resource management device for controlling the base station, or the like. The network device 102 may also include a relay station (relay device), an access point, a base station in a future 5G network, a base station in a future evolved PLMN network, an NR base station, or the like. The network device 102 may be a wearable device or a vehicle-mounted device. The network device 102 may also be a communication chip with a communication module.

For example, the network device 102 includes, but is not limited to, a next generation base station (gnodeB, gNB) in 5G, an evolved node B (eNB) in an LTE system, a radio network controller (RNC), a node B (NB) in a WCDMA system, a radio controller in a CRAN system, a base station controller (BSC), a base transceiver station (BTS) in a GSM system or a CDMA system, a home base station (e.g., a home evolved node B, or a home node B, HNB), a baseband unit (BBU), a transmitting and receiving point (TRP), a transmitting point (TP), a mobile switching center, or the like.

An embodiment of the present disclosure provides a method for receiving and sending a wake-up signal. Reference is made to FIG. 2, which is a method for receiving and sending a wake-up signal shown according to an exemplary embodiment. As shown in FIG. 2, the method includes the steps S201˜S202, which are specifically as follows.

In step S201, the network device 102 sends a wake-up signal (WUS) to the user equipment 101.

In step S202, the user equipment 101 performs a measurement through a low-power transceiver or a main receiver according to the received WUS.

In some implementations, the wake-up signal WUS is a low power wake-up signal (LP WUS).

In some implementations, the network device 102 sends the LP WUS by sending a broadcast message.

In some implementations, the network device 102 indicates an identifier of the user equipment 101 to be awakened.

For example, the network device 102 carries the identifier of at least one user equipment 101 in the LP WUS, or carries the identifier of at least one user equipment 101 in the configuration information corresponding to the LP WUS. The user equipment 101 with the corresponding identifier monitors and receives the LP WUS, and wakes up upon receiving the LP WUS.

In some implementations, the network device 102 may send the configuration information of the LP WUS before sending the LP WUS. The user equipment 101 obtains the time-frequency resources of the LP WUS according to the configuration information of the LP WUS, so as to monitor and receive the LP WUS at an accurate time-frequency position.

In some implementations, the user equipment 101 supports dual transceivers, that is, the user equipment 101 includes a low-power transceiver and a main receiver. The low-power transceiver is configured to monitor and receive WUS, and the main receiver is in a sleep state to save energy before the WUS is received. After the WUS is received, the main receiver wakes up, that is, switches from the sleep state to a working state to perform operations such as data transmission and reception.

In some implementations, the user equipment 101 may be in a radio resource control connected (RRC Connected) state, or, in an RRC idle state, or in an RRC inactive state.

In some implementations, the measurement performed by the user equipment 101 includes: the measurement of the WUS, and/or measurement of a reference signal (RS) configured by the network device 102.

In some implementations, the user equipment 101 performs the measurement of the WUS via a low-power transceiver.

In some implementations, the user equipment 101 performs the measurement of the RS via a main receiver.

In the embodiments of the present disclosure, after receiving the WUS sent by the network device 102, the user equipment 101 may perform measurement either through the low-power transceiver or through the main receiver, thereby achieving effective measurements in the scenario where the low-power transceiver is introduced.

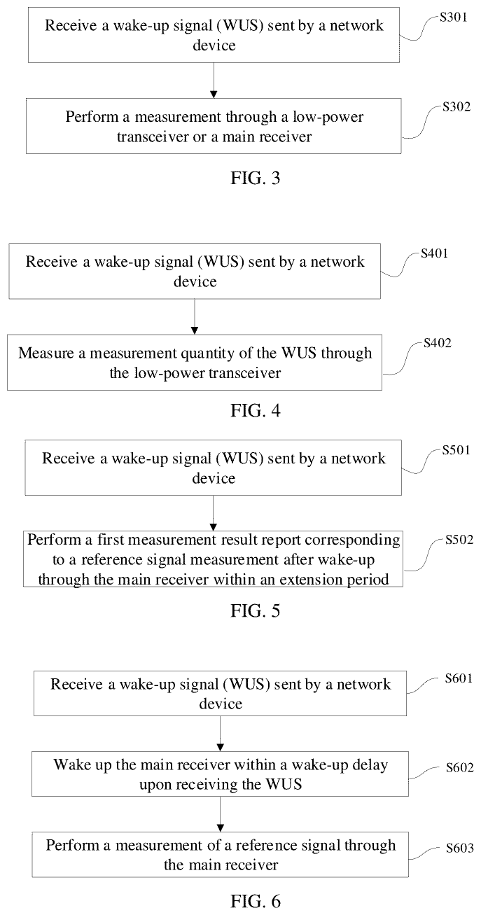

An embodiment of the present disclosure provides a method for receiving a wake-up signal, which is performed by a user equipment 101. Reference is made to FIG. 3, which is a method for receiving a wake-up signal shown according to an exemplary embodiment. As shown in FIG. 3, the method includes the steps S301˜S302, which are specifically as follows.

In step S301, the user equipment 101 receives a wake-up signal (WUS) sent by a network device.

In step S302, the user equipment 101 performs a measurement through a low-power transceiver or a main receiver.

It is worth noting that the sequence of the step S301 and the step S302 is illustrative only rather than restrictive. For example, when performing the measurement through the low-power transceiver, the steps S301 and S302 may be executed synchronously.

In some implementations, the wake-up signal (WUS) is a low power wake-up signal (LP WUS).

In some implementations, the user equipment 101 includes a low-power transceiver and a main receiver. The low-power transceiver is configured to monitor and receive WUS. Before the WUS is received, the main receiver is in a sleep state to save energy. After the WUS is received, the main receiver wakes up, that is, switches from the sleep state to a working state to send and receive data.

In some implementations, the user equipment 101 wakes up the main receiver within a wake-up delay T after receiving the WUS. The network device 102 performs UE scheduling after the wake-up delay.

In an example, the wake-up delay T is defined by the protocol.

In an example, the protocol defines the wake-up delays corresponding to different user equipment capabilities. The user equipment 101 reports the supported capability to the network device 102, and the network device 102 determines the wake-up delay corresponding to the capability of user equipment 101 according to the protocol and the capability reported by the user equipment 101, and performs UE scheduling after the wake-up delay. For example, the capabilities of user equipment 101 include a first capability and a second capability, and the protocol defines the wake-up delays corresponding to the first capability and the second capability, respectively.

In some implementations, the user equipment 101 may be in an RRC connected state, or in an RRC idle state, or in an RRC inactive state.

In some implementations, the measurement performed by the user equipment 101 includes: measurement of the WUS, and/or measurement of the RS configured by the network device 102.

In some implementations, a measurement quantity when the user equipment 101 performs measurement may be based on a configuration of the network device 102.

In an example, the user equipment 101 performs the measurement of the WUS through the low power transceiver. The measurement quantity of the WUS measurement may include at least one of the following: a received signal strength indication (RSSI), a reference signal received power (RSRP), a reference signal received quality (RSRQ), and a signal to interference plus noise ratio (SINR).

In an example, the user equipment 101 performs the measurement of RS through a primary receiver. The measurement quantity of the RS measurement may include at least one of the following: an RSSI, an RSRP, an RSRQ, and an SINR.

In the embodiments of the present disclosure, after receiving the WUS sent by the network device 102, the user equipment 101 may perform measurement through the low power transceiver or the main receiver, thereby achieving an effective measurement in the scenario where the low power transceiver is introduced.

An embodiment of the present disclosure provides a method for receiving a wake-up signal, which is performed by a user equipment 101. Reference is made to FIG. 4, which is a method for receiving a wake-up signal shown according to an exemplary embodiment. As shown in FIG. 4, the method includes steps S401˜S402, which are specifically as follows.

In step S401, the user equipment 101 receives a wake-up signal WUS sent by a network device.

In step S402, the user equipment 101 measures a measurement quantity of WUS through the low-power transceiver.

The step S401 and the step S402 may be executed simultaneously.

In some implementations, before the main receiver wakes up, that is, when the main receiver is in a sleep state, the user equipment 101 performs the measurement of the WUS through the low power transceiver.

In some implementations, the measurement quantity of the WUS may be configured by the network device 102.

In some implementations, the measurement quantity is at least one of the following:
a received signal strength indication RSSI;
a reference signal received power RSRP;
a reference signal received quality RSRQ; and
a signal to interference plus noise ratio SINR.

In an example, according to the configuration of the network device 102, the user equipment 101 measures the RSSI of the WUS through the low-power transceiver.

In the embodiments of the present disclosure, after receiving the WUS, the user equipment 101 may monitor and receive the WUS through the low-power transceiver and perform measurement of the WUS.

An embodiment of the present disclosure provides a method for receiving a wake-up signal, which is performed by a user equipment 101. The method includes steps S401˜S402-1, which are specifically as follows.

In step S401, the user equipment 101 receives a wake-up signal (WUS) sent by a network device.

In step S402-1, the user equipment 101 measures the measurement quantity of the WUS through the low-power transceiver in each measurement period of the WUS.

The sequence of the step S401 and the step S402-1 is for illustration only and not for limitation. For example, when the user equipment 101 receives the WUS in step S401, it may synchronously perform the measurement related to step S402-1.

In some implementations, the measurement quantity of the WUS may be configured by the network device 102.

In some implementations, the measurement quantity is at least one of the following:
a received signal strength indication RSSI;
a reference signal received power RSRP;
a reference signal received quality RSRQ; and
a signal to interference plus noise ratio SINR.

In some implementations, the WUS is a periodic signal, and the user equipment 101 periodically measures the WUS according to the measurement period.

In some implementations, the user equipment 101 may perform multiple samplings within one measurement period, and obtain one measurement result for each measurement period.

In the embodiments of the present disclosure, the user equipment 101 may perform periodic measurement on the WUS through a low-power transceiver.

An embodiment of the present disclosure provides a method for receiving a wake-up signal, which is performed by a user equipment 101. The method includes steps S401, S400 and S402-1, which are specifically as follows.

In step S401, the user equipment 101 receives a wake-up signal WUS sent by a network device.

In step S400, the user equipment 101 determines a measurement period of the WUS according to the period of the WUS, a number of sampling points (sample number) and a constant time.

In step S402-1, the user equipment 101 measures the measurement quantity of the WUS through the low-power transceiver in each measurement period of the WUS.

The sequence of steps S401, S400 and S402-1 is for illustration only and not for limitation. For example, the user equipment 101 may determine the measurement period of the WUS according to step S400 in advance, and then synchronously perform the measurement in step S402-1 when monitoring and receiving the WUS in step S401.

In some implementations, the WUS is a periodic signal, and the period of the WUS may be defined according to a protocol or configured by the network device 102.

In some implementations, the user equipment 101 determines the measurement period of the WUS in the following manner. The measurement period of the WUS is: max (constant time, number of sampling points X period of the WUS).

In an example, the constant time is 400 ms, the number of sampling points is 4, and the period of WUS is 200 ms. The user equipment 101 determines that the measurement period of WUS is max (400 ms, 4×200 ms)=800 ms.

In this example, the user equipment 101 may measure the measurement quantity of WUS four times within each measurement period of 800 ms through the low-power transceiver to obtain a measurement result of the measurement period.

In the embodiments of the present disclosure, the user equipment 101 determines a measurement period for measuring the WUS based on the period of the WUS, performs WUS measurement in each measurement period, and obtains a WUS measurement result in each measurement period.

An embodiment of the present disclosure provides a method for receiving a wake-up signal, which is performed by a user equipment 101. The method includes steps S401˜S402-2, which are specifically as follows.

In step S401, the user equipment 101 receives a wake-up signal WUS sent by a network device.

In step S402-2, the user equipment 101 measures the measurement quantity of the WUS in a one-shot manner through the low-power transceiver.

The sequence of the step S401 and the step S402-2 is for illustration only and not for limitation. For example, when the user equipment 101 receives the WUS in step S401, it can synchronously perform the measurement related to step S402-2.

In some implementations, when performing a one shot measurement on the WUS, the one shot measurement is a measurement of one WUS signal sampling point.

In the embodiments of the present disclosure, the user equipment 101 performs a one-shot measurement on the WUS, and the one-shot measurement may obtain one measurement result.

An embodiment of the present disclosure provides a method for receiving a wake-up signal, where the method is executed by a user equipment 101.

The method includes steps S401, S402-11 and S402-12, which are specifically as follows.

In step S401, the user equipment 101 receives a wake-up signal (WUS) sent by a network device 102.

In step S402-11, the user equipment 101 receives first indication information sent by the network device 102, where the first indication information is used to indicate a measurement quantity.

In step S402-12, the user equipment 101 measures the measurement quantity of the WUS through the low-power transceiver in each measurement period of the WUS.

Alternatively, the method includes steps S401, S402-21 and S402-22, which are specifically as follows.

In step S401, the user equipment 101 receives a wake-up signal (WUS) sent by a network device 102.

In step S402-21, the user equipment 101 receives first indication information sent by the network device 102, where the first indication information is used to indicate a measurement quantity.

In step S402-22, the user equipment 101 measures the measurement quantity of the WUS in a one-shot manner through the low-power transceiver.

In some implementations, the network device 102 may send configuration information of the WUS, where the configuration information includes first indication information to synchronously indicate the measurement quantity of the WUS.

In some implementations, the network device 102 carries the first indication information through the transmitted RRC signaling or DCI.

In some implementations, the measurement quantity is at least one of the following: an RSSI, an RSRP, an RSRQ, and an SINR.

In the embodiments of the present disclosure, the user equipment 101 measures the measurement quantity corresponding to the WUS according to the configuration of the network device 102.

An embodiment of the present disclosure provides a method for receiving a wake-up signal, where the method is executed by a user equipment 101.

The method includes steps S401, S402-12 and S402-13, which are specifically as follows.

In step S401, the user equipment 101 receives a wake-up signal (WUS) sent by a network device 102.

In step S402-12, the user equipment 101 measures the measurement quantity of the WUS through the low-power transceiver in each measurement period of the WUS.

In step S402-13, the user equipment 101 determines whether to wake up a main receiver according to a measurement result of the measurement quantity and a threshold corresponding to the measurement quantity.

Alternatively, the method includes steps S401, S402-22 and S402-23, which are specifically as follows.

In step S401, the user equipment 101 receives a wake-up signal (WUS) sent by a network device 102.

In step S402-22, the user equipment 101 measures the measurement quantity of the WUS in a one-shot manner through the low-power transceiver.

In step S402-23, the user equipment 101 determines whether to wake up a main receiver according to a measurement result of the measurement quantity and a threshold corresponding to the measurement quantity.

In some implementations, the measurement quantity is at least one of the following: an RSSI, an RSRP, an RSRQ, and an SINR.

In some implementations, each measurement quantity has a corresponding threshold.

In some implementations, in a scenario where the WUS is measured according to a measurement period, the user equipment 101 obtains a measurement result of a measurement period, and compares the measurement result of the measurement period with a threshold corresponding to the measurement quantity. One measurement period may include a plurality of sampling points, and the measurement result of one measurement period corresponds to the filtering of the sampling results of the plurality of sampling points.

In some implementations, when an average value of the measurement results obtained in one measurement period is greater than or equal to the threshold corresponding to the measurement quantity, the user equipment 101 determines that the signal quality of the WUS is good and determines to wake up the main receiver. Otherwise, the user equipment 101 does not wake up the main receiver.

In some implementations, after waking up the main receiver, the user equipment 101 may perform mobility measurement through the main receiver, such as measuring a reference signal (RS) of a neighboring cell, or measuring an RS configured by the network device 102.

In some implementations, in a scenario of one-shot measurement of WUS, after the user equipment 101 obtains a measurement result of each single execution of the one-shot measurement, it may compare the measurement result with the threshold corresponding to the measurement quantity.

For example, when the measurement result is greater than or equal to the threshold corresponding to the measurement quantity, the user equipment 101 determines that the signal quality of the WUS is good and determines to wake up the main receiver. Otherwise, the user equipment 101 does not wake up the main receiver.

For another example, when the measurement result is less than a threshold corresponding to the measurement quantity, the user equipment 101 may perform the next one-shot measurement.

In some implementations, the threshold corresponding to the measurement quantity is defined by a protocol.

In some implementations, the threshold corresponding to the measurement quantity is configured by the network device 102.

In some implementations, the network device 102 configures the threshold corresponding to the measurement quantity according to capability information of the user equipment.

In some implementations, before step S402-13 or step S402-23, the user equipment may report capability information of the user equipment to the network device, where the capability information indicates at least one of the following:
a user equipment capability; and
a threshold of the measurement quantity supported by the user equipment capability.

In some implementations, the capability information may include both the user equipment capability and the threshold of the measurement quantity supported by the user equipment capability.

The following lists the implementations in which the capability information indicates the user equipment capability or the threshold of the measurement quantity supported by the user equipment capability.

In some implementations, before step S402-13 or step S402-23, the method may further include the following steps S41˜S42, which are specifically as follows.

In step S41, the user equipment 101 reports capability information of the user equipment to the network device 102, where the capability information includes the user equipment capability.

In step S42, the user equipment 101 receives second indication information sent by the network device 102, where the second indication information is used to indicate a threshold corresponding to the measurement quantity.

In an example, the user equipment capability may represent a capability type of the user equipment.

In an example, the corresponding relationship between different capability types and measurement thresholds may be defined by a protocol. The network device 102 determines the measurement threshold corresponding to the user equipment capability according to the corresponding relationship. The network device 102 may also choose to send second indication information that indicates the threshold to the user equipment 101.

In an example, the network device 102 configures thresholds of the measurement quantity according to different capability types.

In an example, the capability type of the user equipment may be divided into a first type (type 1) and a second type (type 2).

In this example, taking the measurement quantity as the RSSI as an example for illustration, the threshold of the RSSI corresponding to type1 is a fixed value R1, and the threshold of the RSSI corresponding to type2 is R2. Alternatively, the threshold of the RSSI corresponding to type1 includes multiple values.

In this implementation, the network device 102 determines the threshold of a corresponding measurement according to the capability reported by the user equipment 101.

In some implementations, before step S402-13 or step S402-23, the method may further include the following steps S41′ ˜S42, which are specifically as follows.

In step S41′, the user equipment 101 reports the capability information of the user equipment to the network device 102, where the capability information includes the threshold of the measurement quantity supported by the user equipment capability.

In step S42, the user equipment 101 receives second indication information sent by the network device 102, where the second indication information is used to indicate a threshold corresponding to the measurement quantity.

In some implementations, the threshold configured by the network device 102 through the second indication information may be the same as or different from the threshold reported by the user equipment 101.

In this implementation, the network device 102 reasonably configures the threshold of the measurement quantity when measuring the WUS with reference to the threshold supported by the UE capability reported by the user equipment 101. The threshold may be the same as the threshold supported by the UE capability reported by the user equipment 101, or another threshold may be configured with reference to the threshold supported by the UE capability reported by the user equipment 101.

In the embodiments of the present disclosure, the user equipment 101 measures the WUS through the low-power transceiver, and determines whether to wake up the main receiver according to the measurement result of the WUS measurement. Therefore, when the quality of the WUS signal is poor, the main receiver of the user equipment 101 may not be awakened to maintain energy saving, and when the WUS signal quality is good, the main receiver is awakened to perform data transmission and reception in time.

An embodiment of the present disclosure provides a method for receiving a wake-up signal, which is performed by a user equipment 101. Reference is made to FIG. 5, which is a method for receiving a wake-up signal shown according to an exemplary embodiment. As shown in FIG. 5, the method includes steps S501˜S502, which are specifically as follows.

In step S501, the user equipment 101 receives a wake-up signal (WUS) sent by a network device.

In step S502, the user equipment 101 performs a first measurement result report corresponding to a reference signal measurement after wake-up through the main receiver within an extension period.

In some implementations, the measurement performed by the main receiver is an RS-based measurement.

In some implementations, the main receiver performs measurement after being awakened, that is, switching from a sleep state to a working state.

In an example, the low-power transceiver of the user equipment 101 wakes up the main receiver after receiving the WUS.

In an example, the low-power transceiver of the user equipment 101 wakes up the main receiver when receiving a WUS and the measurement value of the WUS is greater than or equal to a threshold corresponding to the measurement quantity.

In some implementations, the network device 102 may configure the RS to be measured, for example, a synchronization signal block (SSB) of a neighboring cell, or a channel state information reference signal (CSI-RS), for the user equipment 101.

In some implementations, the user equipment 101 may determine an extension period based on a measurement period of the RS during the mobility measurement process, where the extension period is extended or prolonged on the measurement period of the RS.

In some implementations, the first measurement result may be obtained based on the first measurement of the main receiver after waking up, or may be obtained based on the Nth measurement of the main receiver after waking up. It is worth noting that during the RS measurement process, the main receiver may report the measurement result to the network device 102 only after the measurement result meets the relevant accuracy requirements.

In some implementations, after the first measurement result is reported, the extension period may be invalid, that is, the extension period is only applicable to the first measurement result report after the main receiver is awakened.

For example, if the first measurement result is obtained from the main receiver's first measurement after waking up, then the extension period is only applicable to the first measurement.

In the embodiments of the present disclosure, the requirement of the measurement period is relaxed for the first measurement result report after the main receiver is awakened. That is, considering the time during which the main receiver may be in a sleep state, the main receiver may complete the first measurement result report within a longer extension period.

An embodiment of the present disclosure provides a method for receiving a wake-up signal, which is performed by a user equipment 101. The method includes steps S501, S500 and S502, which are specifically as follows.

In step S501, the user equipment 101 receives a wake-up signal (WUS) sent by a network device.

In step S500, the user equipment 101 determines an extension period according to an extension coefficient and a reference period.

In step S502, the user equipment 101 performs a first measurement result report corresponding to a reference signal measurement after wake-up through the main receiver within an extension period.

In some implementations, the extension period T satisfies: T=K*T1, where K is the extension coefficient, T1 is the reference period, and K>1.

In some implementations, the extension coefficient is defined by the protocol.

In some implementations, the extension coefficient is configured by the network device 102.

In some implementations, the reference period is a parameter related to the measurement period of the RS.

In some implementations, the reference period includes: a measurement period corresponding to the reference signal measurement. Alternatively, the reference period includes: an identification period and a measurement period corresponding to the reference signal measurement.

In an example, if the sleep time of the main receiver is short, or the neighboring cell corresponding to the RS is still a known cell for the user equipment 101. In this case, the reference period includes the measurement period corresponding to the RS. The measurement period of the RS may be determined according to the number of sampling points of the RS and the period of the RS.

In an example, if the sleep time of the main receiver is long (e.g., greater than 5 seconds), the neighboring cell corresponding to the RS may become an unknown cell for the user equipment 101. In this case, the reference period includes the measurement period corresponding to the RS and the identification period of the cell. The identification period of the cell includes: a detection period of the primary synchronization signal (PSS) or a detection period of the secondary synchronization signal (SSS)+the detection period of the SSB index.

In the embodiments of the present disclosure, the user equipment 101 may extend the measurement period of the RS by in combination with the extension coefficient, so as to perform the measurement within a longer measurement period to implement the first measurement result report.

An embodiment of the present disclosure provides a method for receiving a wake-up signal, which is performed by a user equipment 101. The method includes steps S501, S500-1, S500-2 and S502, which are specifically as follows.

In step S501, the user equipment 101 receives a wake-up signal (WUS) sent by a network device 102.

In step S500-1, the user equipment 101 receives third indication information sent by the network device 102, where the third indication information is used to indicate an extension coefficient.

In step S500-2, the user equipment 101 determines an extension period according to the extension coefficient and a reference period.

In step S502, the user equipment 101 performs a first measurement result report corresponding to a reference signal measurement after wake-up through the main receiver within an extension period.

In some implementations, the network device 102 may dynamically indicate the extension coefficient via DCI.

In the embodiments of the present disclosure, the user equipment 101 determines an extension period according to an extension coefficient configured by the network device, and completes the first measurement result report after wake-up within the extension period.

An embodiment of the present disclosure provides a method for receiving a wake-up signal, which is performed by a user equipment 101. Reference is made to FIG. 6, which is a method for receiving a wake-up signal shown according to an exemplary embodiment. As shown in FIG. 6, the method includes steps S601˜S603, which are specifically as follows.

In step S601, the user equipment 101 receives a wake-up signal (WUS) sent by a network device.

In step S602, the main receiver is awakened within a wake-up delay upon receiving the WUS.

In step S603, the reference signal is measured through the primary receiver.

In some implementations, the starting moment of the wake-up delay is the moment when the UE receives the WUS.

In some implementations, the starting moment of the wake-up delay is the end moment of the transmission time interval (TTI) in which the WUS message is located.

In some implementations, the UE does not need to transmit an uplink signal or receive a downlink signal through the main receiver within the wake-up delay.

In some implementations, the wake-up of the main receiver may refer to a power-on process of the main receiver; it may also refer to that the main receiver is able to perform uplink and downlink transmissions, i.e., it is switched to the working state. In this case, the main receiver needs to perform the synchronization process of the main receiver. Therefore, the end moment of the wake-up delay includes the completion moment of the power-on process of the main receiver or the completion moment of the synchronization process of the main receiver. The synchronization of the main receiver may refer to the measurements of several reference signals.

In some implementations, the wake-up delay is defined by a protocol.

For example, the wake-up delay is a fixed value T. After a duration of T from the moment when the user equipment 101 receives the WUS, the main receiver wakes up. After the main receiver wakes up, it may perform the measurement of the RS according to the configuration of the network device 102.

In some implementations, the wake-up delays corresponding to different user equipment capabilities are defined through a protocol.

For example, the user equipment capability includes a first capability and a second capability, and the protocol may define a wake-up delay corresponding to each capability, see Table 1.

TABLE 1

| | First capability | Second capability |
|---|---|---|
| | (Type 1) | (Type 2) |
| Wake-up delay [ms] | T1 | T2 |

In some implementations, the wake-up delays of each user equipment capability in different sleep states are defined by a protocol.

For example, the sleep states of the main receiver include, from deep to shallow: ultra deep sleep, deep sleep, light sleep and shallow sleep (Micro sleep).

When the user equipment capability includes the first capability and the second capability, the protocol may define wake-up delays thereof in different sleep states, as shown in Table 2. For user equipments with different capabilities, their wake-up delays in the same sleep state are different. For a user equipment with one capability, its wake-up delays in different sleep states are also different.

It is worth noting that the values of the delays in Table 2 are for illustration only and are not intended to be limiting.

TABLE 2

| | | First capability | Second capability |
|---|---|---|---|
| | Sleep state | (Type 1) | (Type 2) |
| Wake-up | Micro sleep | 1 | 3 |
| delay | Light sleep | 2 | 5 |
| [slot] | Deep Sleep | 3 | 9 |
| | Ultra deep | 5 | 18 |
| | sleep | | |

In some implementations, the network device 102 may schedule the UE after the wake-up delay. For example, it may configure mobility-related measurement configuration for the UE, or perform data scheduling.

In some implementations, the requirement of the first measurement after the main receiver of the UE wakes up from a sleep state includes an extension of the original measurement period, and performing measurement within the extended period.

In an example, the extended period meets the following requirements: the wake-up delay+the detection period or the identification period required by the protocol. For example, as shown in Table 3, when the UE enters the idle state or the inactive state from the sleep state, the selection and reselection requirements (Nserv_LPWUS) of the serving cell or the extended period during the first measurement process meets the following Table 3, where the unit of Nserv_LPWUS or the extended period is the number of DRX cycles, Tis the wake-up delay, N1 is the extension coefficient, M1 is a coefficient introduced by the protocol to resolve the conflict between the reference signal measurement and the paging message, and M1 may be equal to 1 or 2.

TABLE 3

| DRX cycle | Extension coefficient | | |
|---|---|---|---|
| length | (N1) | | Nserv_ LPWUS [number of DRX |
| [s] | FR1 | FR2-2 | cycles] |
| 0.32 | 1 | [8] | T + M1*N1*4 |
| 0.64 | | [5] | T + M1*N1*4 |
| 1.28 | | [4] | T + N1*2 |
| 2.56 | | [3] | T + N1*2 |

An embodiment of the present disclosure provides a method for receiving a wake-up signal, which may include the following steps S601, S602-1, S602-2 and S603, which are specifically as follows.

In step S601, the user equipment 101 receives a wake-up signal (WUS) sent by a network device.

In step S602-1, the main receiver is awakened within a wake-up delay upon receiving the WUS.

In step S602-2, capability information of the user equipment is sent to the network device, where the capability information includes the user equipment capability.

In step S603, a reference signal is measured through the main receiver.

In some implementations, the user equipment 101 may send capability information by sending an RRC message. For example, the user equipment 101 sends UECapabilityInformation to report the user equipment capability.

In some implementations, the capability information in the step S41, the capability information in the step S41′, and the capability information in the step S602-2 may be the same capability information. The user equipment capability corresponding to the step S41, the threshold supported by the user equipment capability corresponding to the step S41′, and the user equipment capability corresponding to S602-2 are respectively indicated in different information fields or different bits of the capability information.

In some implementations, referring to Table 1, the protocol defines the wake-up delays corresponding to different user equipment capabilities. Therefore, after the user equipment 101 reports the capability information to the network device 102, the network device 102 can determine the wake-up delay corresponding to the capability of the user equipment 101 according to the protocol and the capability reported by the user equipment 101, and perform UE scheduling after the wake-up delay.

In some implementations, referring to Table 2, the protocol defines the wake-up delays of each user equipment capability in different sleep states. In this case, step S602-2 may adopt the following step S602-2′, which are specifically as follows.

In step S602-2′, the sleep state and capability information of the user equipment are sent to the network device, where the capability information includes the user equipment capability.

In this case, the network device 102 may determine, according to the capability reported by the user equipment 101 and the sleep state thereof, the corresponding wake-up delay of the user equipment 101 under this capability and this sleep state in the protocol, and perform UE scheduling after the wake-up delay.

In some implementations, the user equipment capability is applicable to all frequency bands supported by the user equipment, or the user equipment capability is applicable to a combination of a part of the frequency bands.

In an example, when the user equipment capability is applicable to all supported frequency bands, the user equipment capability is a capability of a specific level (UE specific).

In this case, within the frequency bands supported by the UE, the network device 102 is able to determine the corresponding wake-up delay according to the user equipment capability. In this example, the corresponding wake-up delay may be determined solely according to the user equipment capability, or according to both the user equipment capability and the sleep state of the UE.

In another example, when the user equipment capability is applicable to a partial band combination, the user equipment may declare that it supports some frequency bands. For example, it supports the first frequency band or the second frequency band.

In this case, when the network device 102 performs scheduling in the first frequency band or the second frequency band, the corresponding wake-up delay may be determined with reference to the user equipment capability. However, in other frequency bands, the wake-up delay cannot be determined based on the user equipment capability. In this example, the corresponding wake-up delay may be determined solely based on the user equipment capability, or according to both the user equipment capability and the sleep state of the UE.

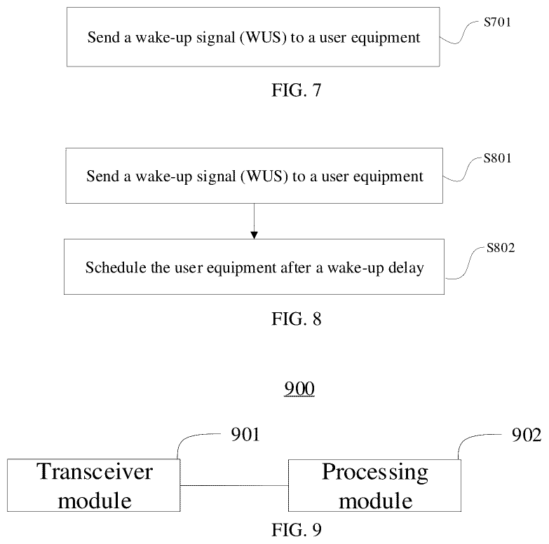

An embodiment of the present disclosure provides a method for sending a wake-up signal, which is performed by a network device 102. Reference is made to FIG. 7, which is a method for sending a wake-up signal shown according to an exemplary embodiment. As shown in FIG. 7, the method includes step S701, which is specifically as follows.

In step S701, the network device 102 sends a wake-up signal (WUS) to the user equipment 101.

In some implementations, the wake-up signal (WUS) is a low-power wake-up signal (LP WUS).

In some implementations, the network device 102 indicates an identifier of the user equipment 101 to be awakened.

For example, the network device 102 carries the identifier of at least one user equipment 101 in the LP WUS, or carries the identifier of at least one user equipment 101 in the configuration information corresponding to the LP WUS. The user equipment 101 with the corresponding identifier monitors and receives the LP WUS, and wakes up upon receiving the LP WUS.

In some implementations, the network device 102 may send the configuration information of the LP WUS before sending the LP WUS. The user equipment 101 obtains the time-frequency resources of the LP WUS according to the configuration information of the LP WUS, so as to monitor and receive the LP WUS at an accurate time-frequency position.

In some implementations, the network device 102 may further receive a measurement report sent by the user equipment 101.

In an example, the measurement report is a measurement report based on the measurement of the WUS of the low-power transceiver of the user equipment 101, and the measurement report includes the measurement result of the WUS.

In an example, the measurement report is a measurement report based on the RS of the main receiver of the user equipment 101, and the measurement report includes the first measurement result after the main receiver wakes up.

In the embodiments of the present disclosure, the network device 102 sends the WUS to the user equipment 101, so that after receiving the WUS, the user equipment 101 may perform a measurement on the WUS based on the low-power transceiver, or perform a measurement on the RS based on the awakened main receiver.

An embodiment of the present disclosure provides a method for sending a wake-up signal, which is performed by a network device 102. The method includes step S701′, which is specifically as follows.

In step S701′, the network device 102 sends a broadcast message, and the broadcast message includes a WUS.

In the embodiments of the present disclosure, the network device 102 may send the WUS in the form of a broadcast message, so that more UEs may obtain the WUS by receiving the broadcast message.

An embodiment of the present disclosure provides a method for sending a wake-up signal, which is performed by a network device 102. The method includes steps S701 to S702, which are specifically as follows.

In step S701, the network device 102 sends a wake-up signal (WUS) to the user equipment 101.

In step S702, the network device 102 sends first indication information to the user equipment 101, where the first indication information is used to indicate a measurement quantity when the user equipment performs the measurement of the WUS.

The order of the steps S701 and S702 is for illustration only and is not intended to be limiting. For example, the step S702 may be performed first, or the two steps may be performed synchronously.

In some implementations, the measurement quantity measured for the WUS may include at least one of the following: a received signal strength indication (RSSI), a reference signal received power (RSRP), a reference signal received quality (RSRQ), and a signal to interference plus noise ratio (SINR).

In an example, the first indication information indicates that the measurement quantity during the WUS measurement is the RSSI.

In the embodiments of the present disclosure, in a scenario where the user equipment 101 measures the WUS based on the low-power transceiver, the network device 102 may configure the measurement quantity of the WUS measurement for the user equipment 101.

An embodiment of the present disclosure provides a method for sending a wake-up signal, which is performed by a network device 102. The method includes steps S701, S703, S704 and S705, which are specifically as follows.

In step S701, the network device 102 sends a wake-up signal (WUS) to the user equipment 101.

In step S703, the network device 102 receives capability information reported by the user equipment, where the capability information indicates the user equipment capability and/or a threshold of the measurement quantity supported by the user equipment capability.

In step S704, the network device 102 determines second indication information according to the capability information, where the second indication information is used to indicate a threshold corresponding to the measurement quantity.

In step S705, the network device 102 sends second indication information to the user equipment 101.

In some implementations, the network device 102 may further configure the measurement quantity of the WUS.

In some implementations, the protocol defines a correspondence between user equipment capabilities and thresholds of measurement quantities. Therefore, the network device 102 can determine the threshold of the measurement quantity that needs to be configured according to the user equipment capability reported by the user equipment 101.

In some implementations, the user equipment 101 reports a threshold supported by itself, and the network device 102 configures the threshold of the measurement quantity with reference to the reported information.

In the embodiments of the present disclosure, the network device 102 adaptively configures the threshold corresponding to the measurement quantity for the user equipment 101 according to the user equipment capability reported by the user equipment 101 or the threshold supported by the user equipment capability.

An embodiment of the present disclosure provides a method for sending a wake-up signal, which is performed by a network device 102. The method includes steps S701 and S706, which are specifically as follows.

In step S701, the network device 102 sends a wake-up signal (WUS) to the user equipment 101.

In step S706, the network device 102 sends third indication information to the user equipment, where the third indication information is used to indicate an extension coefficient.

In some implementations, the extension coefficient is applied to a scenario in which the main receiver of the user equipment 101 performs the measurement.

In some implementations, the network device 102 may dynamically configure the extension coefficient corresponding to the sleep state of the main receiver each time through the DCI.

In some implementations, the extension coefficient >1.

In the embodiments of the present disclosure, the network device 102 configures the extension coefficient for the user equipment 101, so that the user equipment 101 determines an extension period according to the extension coefficient, thereby completing the first measurement result report after wake-up within the extension period.

An embodiment of the present disclosure provides a method for sending a wake-up signal, which is performed by a network device 102. Reference is made to FIG. 8, which is a method for sending a wake-up signal shown according to an exemplary embodiment. As shown in FIG. 8, the method includes steps S801 to S802, which are specifically as follows.

In step S801, the network device 102 sends a wake-up signal (WUS) to the user equipment 101.

In step S802, the user equipment is scheduled after a wake-up delay.

In some implementations, the moment when the WUS sent by the network device 102 is received by the UE is the starting moment of the wake-up delay. That is, after the wake-up delay T starting from the starting moment, the network device 102 considers that the main receiver of the UE has been awakened.

In some implementations, the scheduling of the UE by the network device 102 includes: configuring the reference signal to be measured and measurement configuration information for the UE. The UE may perform mobility measurement according to the configuration of the network device 102, such as measuring the RSSI of the RS.

In some implementations, the wake-up delay is defined by a protocol.

For example, the wake-up delay is a fixed value T. After a duration of T from the moment when the WUS sent by the network device 102 is received by the user equipment 101, the network device 102 considers that the main receiver has been woken up and schedules the UE.

In some implementations, the wake-up delays corresponding to different user equipment capabilities are defined through a protocol.

This implementation mode may refer to Table 1 in the aforementioned embodiment. The user equipment capability includes a first capability and a second capability. The protocol may define a wake-up delay corresponding to each capability.

In some implementations, the wake-up delays of each user equipment capability in different sleep states are defined by a protocol.

This implementation mode may refer to Table 2 in the aforementioned embodiment. The user equipment capability includes a first capability and a second capability. The protocol may define the wake-up delays of each capability in different sleep states.

An embodiment of the present disclosure provides a method for sending a wake-up signal, where the method includes the following steps S801, S800-1, S800-2 and S802′, which are specifically as follows.

In step S801, the network device 102 sends a wake-up signal (WUS) to the user equipment 101.

In step S800-1, capability information sent by the user equipment is received, where the capability information includes the user equipment capability.

In step S800-2, a wake-up delay corresponding to the user equipment capability is determined.

In step S802′, the user equipment is scheduled after the wake-up delay corresponding to the user equipment capability.

In some implementations, referring to Table 1, the protocol defines the wake-up delays corresponding to different user equipment capabilities. Therefore, after the user equipment 101 reports the capability information to the network device 102, the network device 102 may determine the wake-up delay corresponding to the capability of the user equipment 101 according to the protocol and the capability reported by the user equipment 101, and perform UE scheduling after the wake-up delay.

In some implementations, referring to Table 2, the protocol defines the wake-up delays of each user equipment capability in different sleep states. In this case, in step S800-1, the user equipment 101 may report the sleep state in addition to the capability information. The network device 102 can determine, according to the capability reported by the user equipment 101 and the sleep state thereof, the corresponding wake-up delay of the user equipment 101 under this capability and this sleep state in the protocol, and then perform UE scheduling after this wake-up delay.

In some implementations, the user equipment capability is applicable to all frequency bands supported by the user equipment, or the user equipment capability is applicable to a partial frequency band combination.

In an example, when the user equipment capability is applicable to partial band combinations, for example, when it is applicable to the first frequency band, the network device 102 may determine the corresponding wake-up delay with reference to the user equipment capability only when scheduling in the first frequency band, and cannot determine the wake-up delay based on the user equipment capability in other frequency bands. In this example, the corresponding wake-up delay may be determined solely according to the user equipment capability, or according to both the user equipment capability and the sleep state of the UE.

In another example, when the user equipment capability is applicable to all supported frequency bands, within the frequency bands supported by the UE, the network device 102 is able to determine the corresponding wake-up delay through the capability of the user equipment. In this example, the corresponding wake-up delay can be determined solely based on the capability of the user equipment, or it can be determined according to both the capability of the user equipment and the sleep state of the UE.

In the method of the present disclosure, after receiving the WUS sent by the network device, the user equipment may perform measurement through the low-power transceiver or the main receiver, thereby achieving an effective measurement in the scenario where the low-power transceiver is introduced.

Based on the same concept as the above method embodiments, an embodiment of the present disclosure further provides an apparatus for receiving a wake-up signal, which may have the functions of the user equipment 101 in the above method embodiments, and is configured to execute the steps executed by the user equipment 101 provided in the above embodiments. The functions may be implemented by hardware, or may be implemented by software or implemented by hardware executing corresponding software. The hardware or software includes one or more modules corresponding to the functions as described above.

In an implementation, the apparatus 900 shown in FIG. 9 may serve as the user equipment 101 involved in the above method embodiments, and execute the steps performed by the user equipment 101 in the above method embodiments. As shown in FIG. 9, the apparatus 900 may include a transceiver module 901 and a processing module 902 coupled to each other, the transceiver module 901 may be used to support the communication apparatus to perform communication, and the processing module 902 may be used for the communication apparatus to perform processing operations, such as generating information/messages to be sent, or processing received signals to obtain information/messages.

When executing the steps implemented by the user equipment 101, the transceiver module 901 is configured to receive a wake-up signal (WUS) sent by the network device; and the processing module 902 is configured to perform measurement through a low-power transceiver or a main receiver.

In some implementations, the processing module 902 is further configured to measure a measurement quantity of the WUS through the low-power transceiver.

In some implementations, the processing module 902 is further configured to measure the measurement quantity of the WUS through the low-power transceiver during each measurement period of the WUS.

In some implementations, the processing module 902 is further configured to determine the measurement period of the WUS according to a period of the WUS, a number of sampling points, and a constant time.

In some implementations, the processing module 902 is further configured to perform a one-shot measurement for the measurement quantity of the WUS through the low-power transceiver.

In some implementations, the transceiver module 901 is further configured to receive first indication information sent by the network device, where the first indication information is used to indicate the measurement quantity.

In some implementations, the processing module 902 is further configured to determine whether to wake up the main receiver according to a measurement result of the measurement quantity and a threshold corresponding to the measurement quantity.

In some implementations, the threshold corresponding to the measurement quantity is defined by a protocol.

In some implementations, the transceiver module 901 is further configured to report capability information of the user equipment to the network device, where the capability information indicates at least one of the following:
a user equipment capability; and
a threshold of the measurement quantity supported by the user equipment capability.

In some implementations, the transceiver module 901 is further configured to enable the user equipment to receive second indication information sent by the network device, where the second indication information is used to indicate the threshold corresponding to the measurement quantity.

In some implementations, the measured quantity is at least one of the following:
a received signal strength indication (RSSI);
a reference signal received power (RSRP);
a reference signal received quality (RSRQ); and
a signal to interference plus noise ratio (SINR).

In some implementations, the processing module 902 is further configured to perform a first measurement result report corresponding to a reference signal measurement after wake-up through the main receiver within an extension period.

In some implementations, the processing module 902 is further configured to determine the extension period according to an extension coefficient and the reference period.

In some implementations, the extension coefficient is defined by a protocol.

In some implementations, the transceiver module 901 is further configured to receive third indication information sent by the network device, where the third indication information is used to indicate the extension coefficient.

In some implementations, the reference period includes: a measurement period corresponding to the reference signal measurement: or the reference period includes: an identification period and a measurement period corresponding to the reference signal measurement.

In some implementations, the processing module 902 is further configured to wake up the main receiver within a wake-up delay upon receiving the WUS; and perform a measurement of a reference signal through the main receiver.

In some implementations, the wake-up delay is defined by a protocol.

In some implementations, the wake-up delay corresponding to different user equipment capabilities is defined by a protocol; or,
wake-up delays of each user equipment capability in different sleep states are defined by a protocol.

In some implementations, the transceiver module 901 is further configured to send capability information of the user equipment to the network device, where the capability information includes the user equipment capability.

In some implementations, the user equipment capability is applicable to all frequency bands supported by the user equipment, or the user equipment capability is applicable to a combination of a part of the frequency bands.

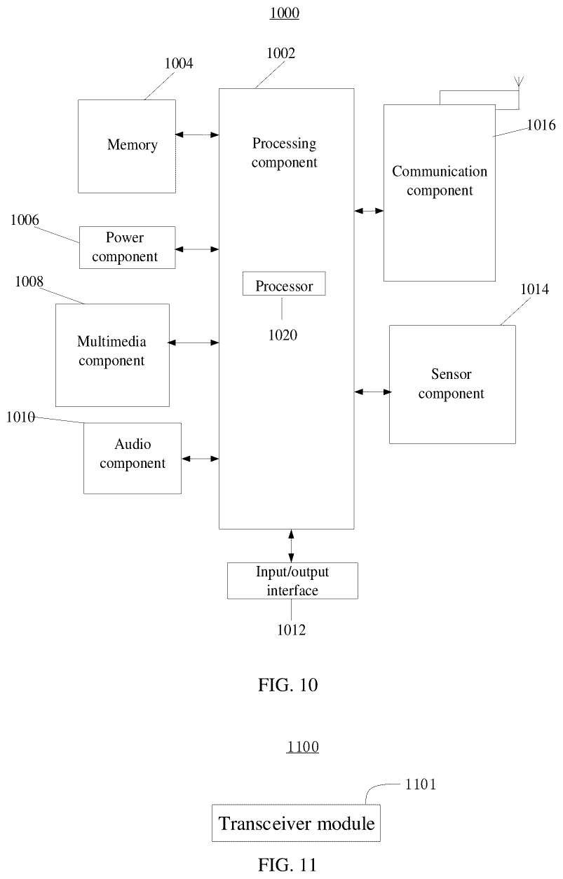

When the communication apparatus is a user equipment 101, the structure thereof may also be as shown in FIG. 10. Referring to FIG. 10, the apparatus 1000 may include one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 typically controls overall operations of the apparatus 1000, such as operations associated with display, telephone calls, data communications, camera operations, and recording operations. The processing component 1002 may include one or more processors 1020 to execute instructions to complete all or some of the steps of the methods as described above. Further, the processing component 1002 may include one or more modules that facilitate interaction between the processing component 1002 and other components. For example, the processing component 1002 may include a multimedia module to facilitate interaction between the multimedia component 1008 and the processing component 1002.

The memory 1004 is configured to store various types of data to support operation at the apparatus 1000. Examples of such data include instructions for any application or method operating on the apparatus 1000, contact data, phone book data, messages, pictures, videos, and the like. The memory 1004 may be implemented by any type of volatile or non-volatile storage device, or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The power component 1006 provides power to various components of the apparatus 1000. The power components 1006 may include a power management system, one or more power sources, and other components associated with generating, managing, and distributing power for the apparatus 1000.

The multimedia component 1008 includes a screen that provides an output interface between the apparatus 1000 and a user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensor may sense not only the boundary of the touch or swipe action, but also the duration and pressure associated with the touch or swipe operation. In some embodiments, the multimedia component 1008 includes a front camera and/or a rear camera. When the apparatus 1000 is in an operating mode, such as a shooting mode or a video mode, the front camera and/or the rear camera may receive external multimedia data. Each of the front camera and the rear camera may be a fixed optical lens system or have focal length and optical zoom capability.

The audio component 1010 is configured to output and/or input audio signals. For example, the audio component 1010 includes a microphone (MIC) configured to receive external audio signals when the apparatus 1000 is in an operating mode, such as a call mode, a recording mode, and a speech recognition mode. The received audio signals may be further stored in the memory 1004 or transmitted via the communication component 1016. In some embodiments, the audio component 1010 further includes a speaker for outputting an audio signal.

The I/O interface 1012 provides an interface between the processing component 1002 and a peripheral interface module, such as keyboards, click wheels, buttons, or the like. These buttons may include, but are not limited to, a home button, a volume button, a start button, and a lock button.

The sensor assembly 1014 includes one or more sensors for providing a state assessment of various aspects of the apparatus 1000. For example, the sensor assembly 1014 may detect an on/off state of the apparatus 1000, and a relative positioning of components, such as a display and a keypad of the apparatus 1100. The sensor assembly 1114 may also detect changes in the position of the apparatus 1000 or one of the components of the apparatus 1000, the presence or absence of user contact with the apparatus 1000, the orientation or acceleration/deceleration of the apparatus 1000, and changes in the temperature of the apparatus 1000. The sensor assembly 1014 may include a proximity sensor configured to detect the presence of an adjacent object in the absence of any physical contact. The sensor assembly 1014 may also include a light sensor, such as a CMOS or CCD image sensor, for use in imaging applications. In some embodiments, the sensor assembly 1014 may further include an acceleration sensor, a gyroscope sensor, a magnetic sensor, a pressure sensor, or a temperature sensor.

The communication component 1016 is configured to facilitate wired or wireless communication between the apparatus 1000 and other devices. The apparatus 1000 may access a wireless network based on a communication standard, such as WiFi, 2G or 3G, or a combination thereof. In one exemplary embodiment, the communication component 1016 receives a broadcast signal or broadcast-related information from an external broadcast management system via a broadcast channel. In one exemplary embodiment, the communication component 1016 further includes a near-field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an exemplary embodiment, the apparatus 1000 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the methods as described above.

In an exemplary embodiment, a non-transitory computer-readable storage medium including instructions, for example, the memory 1004 including instructions, is further provided. The above instructions may be executed by the processor 1020 of the apparatus 1000 to accomplish the methods as described above. For example, the non-transitory computer-readable storage medium may be a ROM, a random access memory (RAM), a CD-ROM, a magnetic tape, a floppy disk, an optical data storage device, and the like.

Based on the same concept as the above method embodiments, an embodiment of the present disclosure further provides a communication apparatus, which may have the functions of the network device 102 in the above method embodiments, and is configured to execute the steps executed by the network device 102 provided in the above embodiments. The functions may be implemented by hardware, or may be implemented by software or implemented by hardware executing corresponding software. The hardware or software includes one or more modules corresponding to the functions as described above.

In an implementation, the apparatus 1100 shown in FIG. 11 may serve as the network device 102 involved in the above method embodiments, and execute the steps performed by the network device 102 in the above method embodiments. As shown in FIG. 11, the apparatus 1100 may include a transceiver module 1101, where the transceiver module 1101 may be used to support the communication apparatus to perform communication, and the transceiver module 1101 may have a wireless communication function, for example, being able to communicate wirelessly with other communication apparatuses through a wireless air interface.

When executing the steps implemented by the network device 102, the transceiver module 1101 is configured to send a wake-up signal (WUS) to a user equipment.

In some implementations, the transceiver module 1101 is further configured to send a broadcast message, where the broadcast message includes the WUS.

In some implementations, the transceiver module 1101 is further configured to send first indication information to the user equipment, where the first indication information is used to indicate a measurement quantity when the user equipment performs a WUS measurement.

In some implementations, the transceiver module 1101 is further configured to receive capability information reported by the user equipment, where the capability information indicates a user equipment capability and/or a threshold of a measurement quantity supported by the user equipment capability.

The apparatus 1100 further includes a processing module coupled to the transceiver module 1101, where the processing module is configured to determine second indication information according to the capability information, where the second indication information is used to indicate a threshold corresponding to the measurement quantity.

The transceiver module 1101 is further configured to send second indication information to the user equipment.

In some implementations, the transceiver module 1101 is further configured to send third indication information to the user equipment, where the third indication information is used to indicate an extension coefficient.

In some implementations, the processing module is further configured to schedule the user equipment after a wake-up delay.

In some implementations, the wake-up delay is defined by a protocol.

In some implementations, wake-up delays corresponding to different user equipment capabilities are defined by a protocol: or,
wake-up delays of each user equipment capability in different sleep states are defined by a protocol.

In some implementations, the transceiver module 1101 is further configured to receive capability information sent by the user equipment, where the capability information includes the user equipment capability.

The processing module is further configured to determine the wake-up delay corresponding to the user equipment capability.

In some implementations, the processing module is further configured to schedule the user equipment after the wake-up delay corresponding to the user equipment capability.

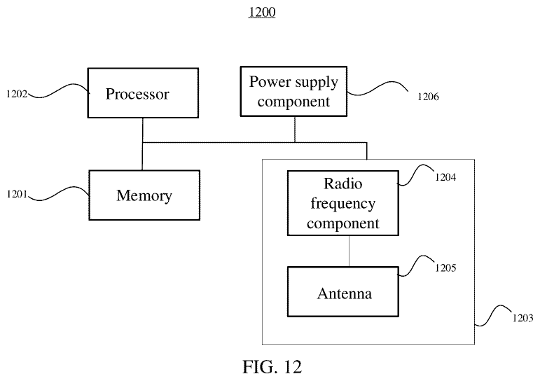

When the communication apparatus is the network device 102, the structure thereof may also be as shown in FIG. 12. The structure of the communication apparatus will be described by taking a base station as an example. As shown in FIG. 12, the apparatus 1200 includes a memory 1201, a processor 1202, a transceiver component 1203, and a power supply component 1206. The memory 1201 is coupled to the processor 1202, and may be used to store programs and data necessary for the communication apparatus 1200 to implement various functions. The processor 1202 is configured to support the communication apparatus 1200 to perform corresponding functions in the above methods, and the functions may be realized by calling a program stored in the memory 1201. The transceiver component 1203 may be a wireless transceiver and may be used to support the communication apparatus 1200 to receive signaling and/or data and transmit signaling and/or data over a wireless air interface. The transceiver component 1203 may also be referred to as a transceiver unit or a communication unit, and may include a radio frequency component 1204, which may be a remote radio unit (RRU) specifically used for transmitting radio frequency signals and conversion between radio frequency signals and baseband signals, and one or more antennas 1205 specifically used for radiating and receiving radio frequency signals.

When the communication apparatus 1200 needs to transmit data, the processor 1202 may perform baseband processing on the data to be transmitted, and then output a baseband signal to a radio frequency unit, and the radio frequency unit performs radio processing on the baseband signal and then transmits the radio frequency signal in the form of electromagnetic waves through an antenna. When data is transmitted to the communication apparatus 1200, the radio frequency unit receives the radio frequency signal through the antenna, converts the radio frequency signal into a baseband signal, and outputs the baseband signal to the processor 1202, and the processor 1202 converts the baseband signal into data and processes the data.

Other implementations of the embodiments of the present disclosure will readily occur to those skilled in the art upon consideration of the specification and practice of the disclosure disclosed herein. The present application is intended to cover any modifications, uses, or adaptations of the embodiments of the present disclosure, which follow the general principles of the embodiments of the present disclosure and include common knowledge or conventional technical means in the technical field not disclosed in the present disclosure. The specification and embodiments are to be regarded as exemplary only, and the true scope and spirit of the embodiments of the present disclosure are indicated by the following claims.

It should be understood that the embodiments of the present disclosure are not limited to the precise structures described above and illustrated in the accompanying drawings, and various modifications and changes may be made without departing from the scope thereof. The scope of embodiments of the present disclosure is limited only by the appended claims.

### INDUSTRIAL PRACTICALITY

In the method of the present disclosure, after receiving the WUS sent by the network device, the user equipment may perform measurement through the low-power transceiver or the main receiver, thereby achieving an effective measurement in the scenario where the low-power transceiver is introduced.

1. A method for receiving a wake-up signal, performed by a user equipment, comprising:
receiving a wake-up signal (WUS) sent by a network device; and
performing a measurement through a low-power transceiver or a main receiver.

2. The method according to claim 1, wherein performing the measurement through the low-power transceiver or the main receiver comprises:
measuring a measurement quantity of the WUS through the low-power transceiver in each measurement period of the WUS.

3. (canceled)

4. The method according to claim 2, further comprising:
determining a measurement period of the WUS according to a period of the WUS, a number of sampling points, and a constant time.

5. (canceled)

6. The method according to claim 2, further comprising at least one of:
receiving first indication information sent by the network device, wherein the first indication information indicates the measurement quantity; or
determining whether to wake up the main receiver according to a measurement result of the measurement quantity and a threshold corresponding to the measurement quantity.

7. (canceled)

8. (canceled)

9. The method according to claim 6, further comprising: reporting capability information of the user equipment to the network device, wherein the capability information indicates at least one of:
a user equipment capability; or
a threshold of the measurement quantity supported by the user equipment capability,
wherein the method further comprises:
receiving, by the user equipment, second indication information sent by the network device, wherein the second indication information indicates the threshold corresponding to the measurement quantity.

10. (canceled)

11. The method according to claim 2, wherein the measurement quantity comprises at least one of:
a received signal strength indication (RSSI);
a reference signal received power (RSRP);
a reference signal received quality (RSRQ); or
a signal to interference plus noise ratio (SINR).

12. The method according to claim 1, wherein performing the measurement through the low-power transceiver or the main receiver comprises:
performing a first measurement result report corresponding to a reference signal measurement after wake-up through the main receiver within an extension period.

13. The method according to claim 12, further comprising:
determining the extension period according to an extension coefficient and a reference period.

14. The method according to claim 13, wherein the extension coefficient is defined by a protocol, or
the method further comprises:
receiving third indication information sent by the network device, wherein the third indication information indicates the extension coefficient.

15. (canceled)

16. The method according to claim 13, wherein the reference period comprises: a measurement period corresponding to the reference signal measurement; or, the reference period comprises: an identification period and a measurement period corresponding to the reference signal measurement.

17. The method according to claim 1, wherein performing the measurement through the low-power transceiver or the main receiver comprises:
waking up the main receiver within a wake-up delay upon receiving the WUS; and
performing a measurement of a reference signal through the main receiver.

18. The method according to claim 17, wherein the wake-up delay is defined by a protocol; or
wake-up delays corresponding to different user equipment capabilities are defined by a protocol; or
the wake-up delay of each user equipment capability in different sleep states is defined by a protocol.

19. (canceled)

20. The method according to claim 17, further comprising:
sending capability information of the user equipment to the network device, wherein the capability information comprises a user equipment capability,
wherein the user equipment capability is applicable to all frequency bands supported by the user equipment, or the user equipment capability is applicable to a combination of a part of the frequency bands.

21. (canceled)

22. A method for sending a wake-up signal, performed by a network device, comprising:
sending a wake-up signal (WUS) to a user equipment; and
sending first indication information to the user equipment, wherein the first indication information indicates a measurement quantity when the user equipment performs a WUS measurement.

23. (canceled)

24. (canceled)

25. The method according to claim 22, further comprising:
receiving capability information reported by the user equipment, wherein the capability information indicates at least one of a user equipment capability or a threshold of a measurement quantity supported by the user equipment capability;
determining second indication information according to the capability information, wherein the second indication information indicates a threshold corresponding to the measurement quantity; and
sending the second indication information to the user equipment.

26. (canceled)

27. The method according to claim 22, further comprising:
scheduling the user equipment after a wake-up delay.

28. The method according to claim 27, wherein the wake-up delay is defined by a protocol; or
wake-up delays corresponding to different user equipment capabilities are defined by a protocol; or
the wake-up delay of each user equipment capability in different sleep states is defined by a protocol.

29. (canceled)

30. The method according to claim 28, further comprising:
receiving capability information sent by the user equipment, wherein the capability information comprises the user equipment capability; and
determining the wake-up delay corresponding to the user equipment capability, wherein scheduling the user equipment after the wake-up delay comprises:
scheduling the user equipment after the wake-up delay corresponding to the user equipment capability.

31.-33. (canceled)

34. A communication apparatus, comprising:
a processor; and
a memory storing a computer program executable by the processor;
wherein the processor is configured to:
receive a wake-up signal (WUS) sent by a network device; and
perform a measurement through a low-power transceiver or a main receiver.

35. A communication apparatus, comprising:
a processor; and
a memory storing a computer program executable by the processor;
wherein the processor is configured to perform the method according to claim 22.

36. (canceled)

37. (canceled)
